(19) United States
(12) Patent Application Publication
(10) Pub. No.: US 2011/0138207 A1
(43) Pub. Date: Jun. 9, 2011

(54) POWER CONTROL AND OPERATION METHOD FOR NOTEBOOK COMPUTER

(76) Inventors: Chen-Wei SU, Taipei City (TW); Tsung-Han Tsai, Taipei City (TW); Chun-Ping Fang, Taipei City (TW)

(21) Appl. No.: 12/633,041

(22) Filed: Dec. 8, 2009

(51) Int. Cl. G06F 1/32; G06F 3/16

(52) U.S. Cl. 713/323; 715/727

(57) ABSTRACT

A power control and operation method of a notebook computer is disclosed. The notebook computer has a display and a switch is activated when the display is closed. The operation procedure comprises steps of activating the program in advance and detecting via an audio receiver/player whether the proceeding setup of the system is in idle state when the display closed; if it isn't, an voice inquiry is sent out for whether to change proceeding setup of the system in idle state to enable user to continue operating the notebook computer; after detecting the signal for display closed, the detection is repeated to the proceeding setup of the system or to inquire whether to change the proceeding setup as idle state, then shut down the display power and activate the voice identifier for further operating the notebook computer. Thus the user can operate the notebook computer by the voice control even without using the keyboard or the touch panel to substantially enjoy the convenience.

### FIELD OF THE INVENTION

The present invention relates to a power control and an operation method for notebook computer, and more particularly after closing the display of the notebook, the user can still operate the notebook computer without operating the keyboard or touch panel via power control and activating voice identifier.

### DESCRIPTION OF RELATED ART

Along with the comprehensive usage of computer and the advanced related technology, the computer has become more common in people's daily life. Computer is not only to used to check information, listen to music, watch movies and contact other users at home, but also is used for communicating in business connections or meetings at work even without presenting it to the person whom the user wish to speak to. As the market has been developed internationally, the people commonly communicate with others from different countries, and internet has become the most convenient means for such remote communication.

The notebook computer is developed with the gradually improved technology, and the weight, the size and the pricing thereof are accordingly reduced. Because the notebook computer need not be fixed in one particular spot like a desktop computer, the user can use the notebook computer anywhere as needed, and therefore the notebook computer is more popularly used and the need of purchasing is also increasing likewise. And the mature wireless network interests the government or service provider to setup more wireless connections for the users to operate their notebook computers more freely in many areas to substantially make the notebook usage more practical and more convenient.

However, the notebook computer has the main body and the display, and the user has to flip open the display panel to press the key installed in the main body or to use the touch panel; while walking or taking public transportation, the monitor has to be attached to the main body to make the notebook computer standby or even shut down for the sake of convenient transportation, and during the transportation, the notebook computer is not operable since the display panel is closed. Thus, the user has to terminate the web communication while walking or taking the public transportation, or even getting away for emergency, and the web communication can be restarted only after the user has reached the destination and restart the notebook computer. Nevertheless, different countries have time differences and the people in the modern era are very busy, by the time the user reaches the destination the contact at the other end may not be reached; therefore, notebook computer still has its defect of being inconvenient to the user.

Therefore, to carry the notebook computer and use it while traveling has defect for being unable to operate when the display panel is close for standing by or for shutting down the power, and how to overcome the above conventional defects is an important issue for the manufacturers in the field.

### SUMMARY OF THE INVENTION

An object of the present invention is to provide a power control and operation method of the notebook computer to enable the user to operate the notebook computer even while carrying it.

According to an aspect of the present invention, the program and to sense the connection of the audio receiver/player are activated as well as the original system processing setup is sensed to inquire whether to modify the setup when the processing setup is not idling. Furthermore, when the signal for sensing that the display panel is closed, the sensing process will repeat and the inquiry will be sent to whether or not to modify the processing setup. Thus, even the display panel is closed, and the power to the display panel is terminated, the voice identifier can still be activated to operate the system to enable the user to work on the notebook computer while driving, walking or taking public transportation. The user can operate the notebook computer through the voice identifier when the notebook computer is placed aside or even in a bag, therefore, the notebook computer can be upgraded to be a more comprehensive tool.

According to another aspect of the present invention, the user can implement two ends or multi ends communication, such as meeting or internet call without stationing at the same post, thus the communication or work doesn't have to be interrupted, and the efficiency thereof can be upgraded as well as to substantially reduce the time consumption.

According to another aspect of the present invention, before activating the voice identifier when the display power of the notebook computer is turned off, the user can setup sending out the message for whether to shut down the power when the power is low, thus to prevent exhausting the battery and shutting down the notebook computer without warning. Accordingly, the notebook computer can be upgraded to be more stable, convenient and maximum usage.

### BRIEF DESCRIPTION OF THE DRAWING

For more complete understanding of the present invention, reference will now be made to the following detailed description of preferred embodiments taken in conjunction with the following accompanying drawings.

FIG. 1 is a block diagram of a power control and operation method for notebook computer according to an embodiment of the present invention.

FIG. 2a is a first operation procedure according to an embodiment of the present invention.

FIG. 2b is a second operation procedure according to another embodiment of the present invention.

FIG. 3 is a block diagram of a power control and operation method for notebook computer according to another embodiment of the present invention.

FIG. 4 is a block diagram of a power control and operation method for notebook computer according to another embodiment of the present invention.

### DETAIL DESCRIPTION OF THE INVENTION

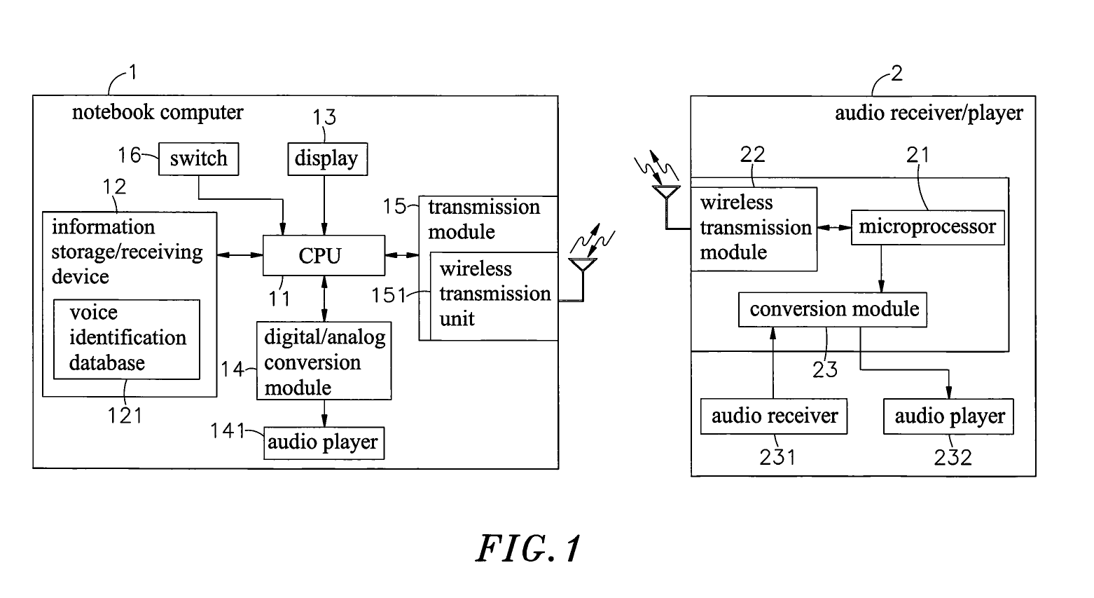

FIG. 1 is a block diagram, a first operation procedure and a second operation procedure according to an embodiment of the present invention. The power control and the method can be applied in a notebook computer 1 and an audio receiver/player 2.

The notebook computer 1 comprises a CPU 11 connected to an information storage/retrieving device 12 having a voice identification database 121, wherein the CPU 11 is connected to a display panel 13 to display images; a digital/analogue conversion module 14 having an audio player 141, a transmission module 15 and a switch 16. The notebook computer 1 may also be connected to an internet device, a wireless interne device, a CD-ROM, battery or other devices. However, the structure and the internal elements of the notebook computer 1 are the common knowledge to those skilled in the art; therefore, detailed description thereof will be described hereinafter.

The audio receiver/player 2 is connected to a wireless receiver/retriever module 22 and the conversion module 23 by the microprocessor 21, and the conversion module 23 is connected to an audio receiver 231 and an audio player 232.

When the display panel 13 of the notebook computer 1 is closed, the display panel 13 touches the switch 16 and sends out a panel closed signal message to notify that the panel is closed, and the system of notebook computer 1 goes to standby, shut down or idle state after receiving the panel closed signal. The procedure of using the present invention to activate the program and to detect whether the notebook computer 1 is connected to the audio receiver/player 2 is provided. The program shuts down when the notebook computer 1 is not connected to the audio receiver/player 2, or the proceeding setup of the system is idle is detected when connected to the audio receiver/player 2. If the proceeding setup is detected to be idle, the notebook computer 1 can still be operated, and if the proceeding setup is detected to be in standby or shun down state, the inquiry will be sent for whether or not changing the system setup to idle state; the CPU 11 will play the voice message when the software is non-functional after the lid is closed. The system can be setup to operate in idle state through the audio player 141 of the digital/analogue conversion module 14 so that the user can continue to use the notebook computer 1 without changing the proceeding setup, and the proceeding setup of the system goes to idle state to enable the user to continue using the notebook computer 1 if the user intends to change the setup.

When continuing to use the notebook computer 1, the program detects whether the signal for display 13 closed is received. If the signal of display closed is not yet received, the notebook computer 1 can be operated continuously and the detection process step is repeated, and if the signal of display closed is received, the proceeding setup of the system detects whether it is in the idle state. If the proceeding setup is in idle state, the voice identifier will be activated to proceed the operation of the notebook computer 1 and shut down the power of the display 13; if the proceeding setup is in standby or shut down state, the original proceeding setup of the system will be restored and the proceeding setup will be changed into idle state to prevent notebook computer 1 from directly shutting down or going to standby state, and the inquiry of whether to change the setup of the system into idle state will be notified in audio state; if the user doesn't change the setting, the original proceeding setup stored therein will be restored to enable the notebook computer 1 to execute on-hand proceeding setup to shut down or standby state; if the user change the setting, the proceeding setup of the system goes to idle state, and the power of display 13 will be shut down and the voice identifier will be activated in order to operate the notebook computer 1.

The above idle state of the proceeding setup is used as a condition of the default setting value, and the condition can also be a continuous operation, no shut down or other conditions in the same meaning of which simply indication that the notebook computer 1 will not shut down and only the display 13 goes to power off state after display 13 is closed, and the notebook computer 1 can still be operated; therefore, the condition therein is not for limiting the scope of the present invention, any modification and structural changes thereof shall be construed to be within the scope of the present invention.

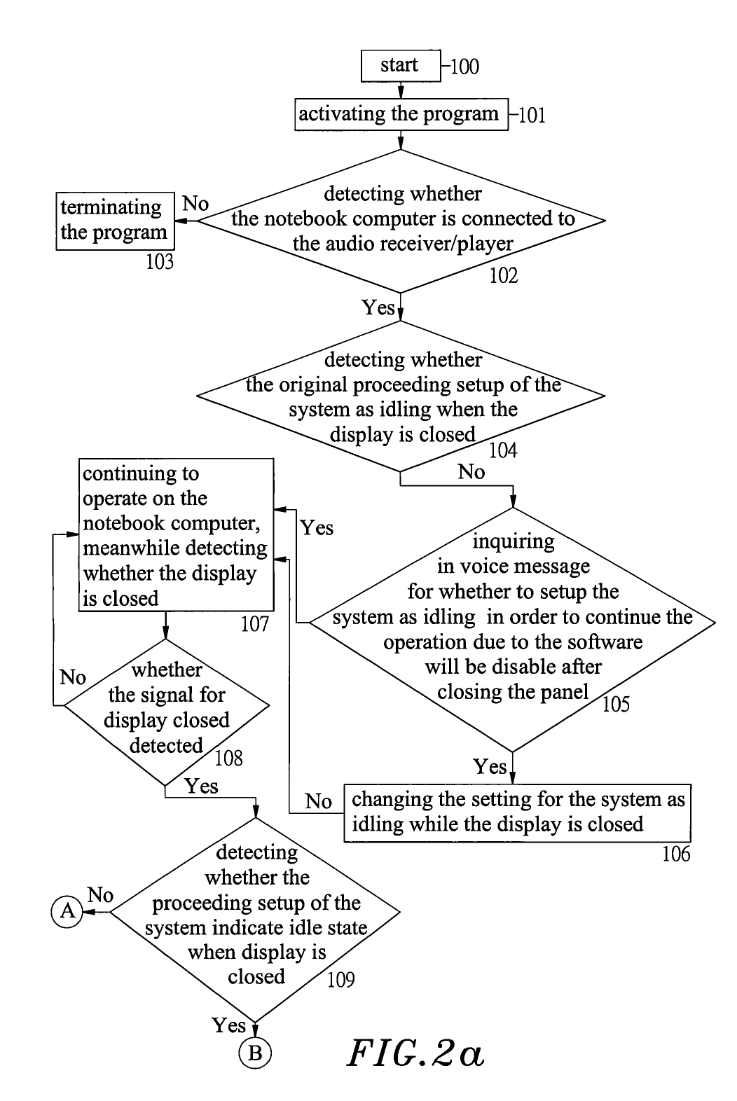

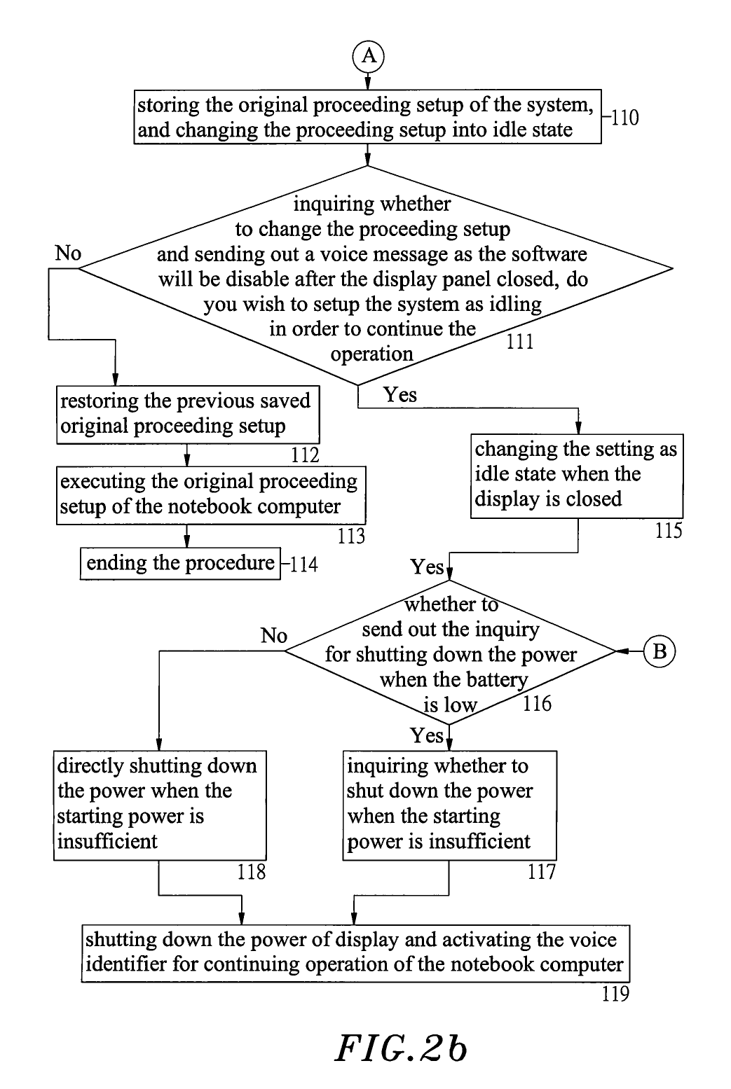

Referring to FIGS. 1, 2a and 2b, a block diagram, a first operation procedure and a second operation procedure for operating the notebook computer 1 are illustrated, which may be described as follows.

At step 100, the procedure is started.

At step 101, the program is activated.

At step 102, whether the notebook computer 1 is connected to the audio receiver/player 2 is detected; wherein if notebook computer 1 is not connected to the audio receiver/player 2, the procedure proceeds to step 103; otherwise the procedure proceeds to step 104.

At step 103, the program is terminated.

At step 104, whether the original proceeding setup of the system is in idle state when the display 13 closed is detected; wherein if it is not, the procedure proceeds to step 105, otherwise the procedure proceeds to step 107.

At step 105, whether to setup the system is in idle is inquired in voice message in order to continue the operation as the software will be disabled after closing the panel; wherein if it is, then the procedure proceeds to step 106, otherwise the procedure proceeds to step 107.

At step 106, the setting for the system as in idle state while the display 13 closed is changed.

At step 107, the notebook computer 1 is continuously operated; meanwhile, whether the display 13 closed is being detected.

At step 108, whether the signal for display 13 closed is detected, wherein if yes, the procedure proceeds to step 109, otherwise the procedure proceeds to step 107.

At step 109, whether the proceeding setup of the system indicate idle state when display 13 closed is detected, wherein if it is yes, the procedure proceeds to step 116, otherwise the procedure proceeds to step 110.

At step 110, the original proceeding setup of the system is restored, and the proceeding setup is changed into idle state.

At step 111, whether to change the proceeding setup is inquired and a voice message as the software is disabled after the display panel closed “do you wish to setup the system as idle state in order to continue the operation” is sent out, wherein if it is not, the proceeds to step 112, otherwise the procedure proceeds to step 115.

At step 112, the previously saved original proceeding setup is restored.

At step 113, the original proceeding setup of the notebook computer 1 is executed.

At step 114, the procedure is ended.

At step 115, the setting as idle state when the display 13 closed is changed.

At step 116, whether or not to send out the inquiry for shutting down the power when the battery is low determined, wherein if it is yes, the procedure proceeds to step 117, otherwise the procedure proceeds to step 118.

At step 117, whether to shut down the power when the starting power is insufficient is judged, and the procedure proceeds to step 119.

At step 118, the power is directly shut down when the starting power is insufficient.

At step 119, the power of display 13 is shut down and the voice identifier for continuing operating the notebook computer 1 is activated.

When activating the voice identifier, because the notebook computer 1 has activated the transmission module 15 with a wireless transmission unit 151 and is connected to the audio receiver/player 2, the user can speak to the audio receiver 231 of the audio receiver/player 2 to let the conversion module 23 convert the analogue information into the digital audio information and further transmit to the microprocessor 21. The microprocessor 21 further wirelessly transmits the digital audio information via the wireless transmission module 22 to the CPU 11 through the wireless transmission unit 151 of the transmission module 15 in the notebook computer 1, the CPU 11 will start processing the voice identification to the digital audio information by matching with the audio identification database 121 of the information storing/retrieving device 12 and then processes the corresponding process based on the matching result; if the system proceeds the work, the title and the content of the work will be matched with the default words, phrases or commands stored in the audio identification database 121, and the CPU 11 will send out the match result through the wireless transmission unit 151 of the wireless transmission module 15 and the wireless transmitting module 22 to the microprocessor 21 for further converting the digital information into analogue information by the conversion module 23 for the player 232 to play.

The above receiver 231 can be a microphone and the player 232 can be an earphone, speaker or other audio player. If the user is using the internet communication before closing the display 13 of the notebook computer 1, the above procedure helps to directly convert the text message into voice message and play out, and on the contrary, the words from the user can also be converted into text message and transmitted out. Thus, the user can still control the notebook computer 1 even without operating the keyboard or touch panel while the display 13 of the notebook computer 1 closed during transportation, and the internet communication with friends, clients or coworkers can be continued without interruption. If the email program is active, the user can use voice message to notify the contacts while receiving the mail or further proceed audio playing for learning the content of the mail, and then to speak out to reply the mail directly. Furthermore, the control method of the present invention enables the user to use the notebook computer 1 to surf the internet, write articles or listen to music as long as the commands are pre-programmed into the voice identification database 121.

Furthermore, the program will send an inquiry to the user to confirm whether to shut down the power when the battery is low while the display 13 is closed and the proceeding setup is in idle are detected, if it is yes, the inquiry function for shutting down power while low battery is activated to shut down the power of the display 13 and the voice identifier is activated for operating the notebook computer 1; otherwise, the power is directly shut down and then the power of display 13 is shut down when the battery power is low, and the voice identifier is activated for operating the notebook computer 1. Generally, the notebook computer 1 indicates the low battery signal through the display 13 or the brightness of the display 13 is reduced to notify the user; however, the user won't be aware of the power remaining in the battery of the notebook computer 1 after the display 13 is closed; therefore, the above function and setting procedure enables the user to setup according to the personal habit to shut down the notebook computer 1 directly when the battery is low, or to inquire whether to continue operation or to shut down the power, in order to prevent damaging of the files or to cut out the communication due to the sudden power shut down caused by exhausting the battery, thus promote the convenience and increase the stability.

The level setup as low battery for above notebook computer 1 can be for example 5%, 6%, 20% or others, can be used to serve as the threshold for notifying the user or to proceed the programmed functions, to confirm whether to shut down the power when the battery is low, also to inquire whether to continue the operation of the notebook computer 1 and before detecting whether the display 13 closed in order to prevent sudden shutting down of the notebook computer 1. The description above is merely used for demonstrating the embodiment of the present invention, any modification or changes illustratively or constructively shall be construed to be within the scope of present invention.

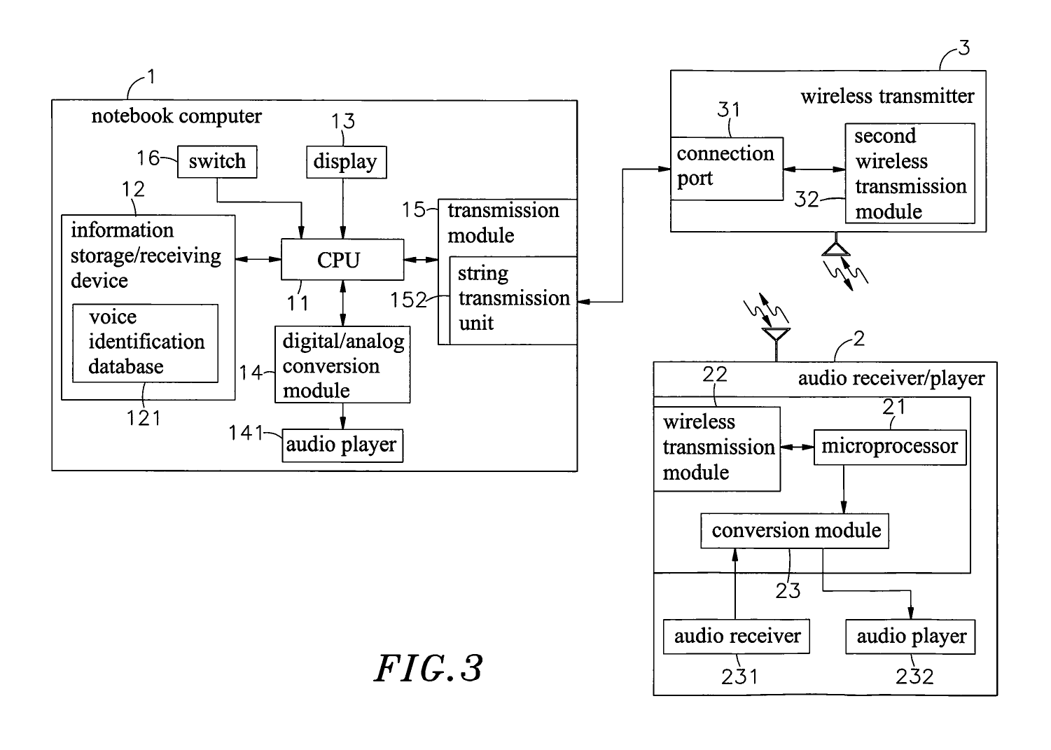

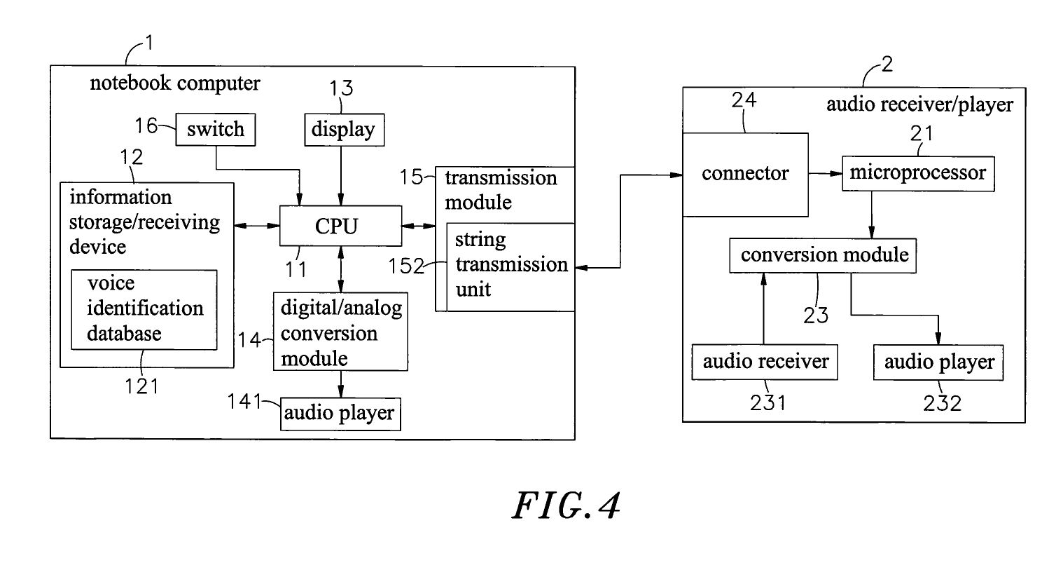

Referring to FIGS. 1, 3 and 4, a block diagram, a block diagram and a block diagram of a power control and operation method for notebook computer according to another embodiment of the present invention are illustrated. When the transmission module 15 of the notebook computer 1 comprises a string transmission unit 152, the string transmission unit 152 can be connected to the connection port 31 of the wireless transmitter 3. The wireless transmitter 3 is connecting to a second wireless transmission module 32 by the connection port 31 to enable the notebook computer 1 to transmit the information from the CPU 11 in orderly manner through the string transmission unit 152 of the transmission module 15, the connection port 31 to the second wireless transmission module 32, and the notebook computer 1 can transmit information mutually with the audio receiver/player 2 wirelessly through the wireless transmitter 3. When the notebook computer 1 receives information, the transmission can be reversed. Furthermore, the notebook computer 1 can also use the string transmission unit 152 of the transmission module 15 to plug with the audio receiver/player 2. The audio receiver/player 2 is connected to a connector 24 and a conversion module 23 by the microprocessor 21; the conversion module 23 is connected to an audio receiver 231 and an audio player 232; the notebook computer 1 and the audio receiver/player 2 can mutually transmit information through the connected transmission module 15 and the connector 24. The audio receiver/player 2 can directly use the built-in audio receiver 231 and the audio player 232 for retrieving or playing voices.

The above notebook computer 1 can be connected to the audio receiver/player 2 and the wireless transmitter 3, and the audio receiver/player 2 can comprise the wireless transmission component for enabling transmitting information. The devices connected to the notebook computer 1 comprises functions of retrieving sound, playing sound and mutual transmitting information, can be an earphone, a detached microphone and a speaker, wired or wireless; the devices can also comprise volume regulator, key, rotation regulator, light emitting element or other components with other functions without limiting the scope of the present invention. Any modification or changes illustratively or constructively shall be construed to be within the scope of present invention.

The wireless transmission unit 151 of the transmission module 15 in the notebook computer 1, the wireless transmission module 22 of the audio receiver/player 2 and the second wireless transmission module 32 of the wireless transmitter 3 can be in the wireless transmission specification of Bluetooth, ZigBee or wireless radio frequency. The string transmission unit 152 of the transmission module 15 in the notebook computer 1, the connection port 31 of the wireless transmitter 3 and the connector 24 of the audio receiver/player 2 can be the universal string bus, for example USB 1.0, USB 2.0 or USB 3.0.

The present invention has at least the following advantages.

When the audio receiver/player 2 is detected to be connected, if the proceeding setup of the system is not in idle state when the display 13 is closed, the user can be notified with voice message for whether to change the setting into idle state to make the proceeding setup to be idle, thus when the user is driving, walking or taking public transportation and the notebook computer 1 is set aside with the display 13 closed, the audio receiver/player 2 and the wireless transmitter 3 can enable the user to operate the notebook computer 1 by speaking out the commands for retrieving/sending emails and text messages, surfing internet, writing articles or listening to music. Thus, the user can enjoy more convenience of using the notebook computer 1.

The present invention enables the user to continue the meeting, internet communication at two ends or multiple ends conference without interruption even leaving the present location;

The present invention enables the user to setup the inquiry for whether to shut down the power when the battery low after the display 13 of the notebook computer 1 closed, the power can be shut down directly or otherwise according to the user's need, thus to prevent the sudden shut down caused by battery exhaustion in the notebook computer 1.

The present invention particularly provides the power control and operation method for the notebook, when starting up the notebook computer 1 and the audio receiver/player 2 is detected to be connected, whether the proceeding setup of the system is in idle state is detected and whether the user wants to change the non-idle setup is inquired, and then the operation on the notebook computer 1 is proceeded; when the signal of display 13 closed is received, the detection step is repeated and whether to change the proceeding setup into idling for enabling the voice identifier after the display 13 of the notebook computer 1 closed is inquired. Thus, enables the user to operate the notebook computer 1 without using the keyboard and the touch panel when the display 13 is closed by using the voice identification to accordingly increase the convenience of the notebook computer 1.

While the invention has been described in conjunction with a specific best state, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A power control and operation method for notebook computer after closing a display of said notebook computer, power can be controlled to enable user to operate said notebook computer when connected to an audio receiver/player; said notebook computer comprising a CPU, an information receiver/saver connected to said CPU, a display and a switch activated while said display closed; said information receiver/saver has a program stored inside, operation method comprising:
(a) starting the operation method;
(b) activating said program;
(c) detecting whether said notebook computer is connected to said audio receiver/player; and proceeding to step (d) if it is determined that the notebook computer is not connected to said audio receiver/player; otherwise proceeding to step (e) otherwise;
(d) terminating said program;
(e) detecting whether an original proceeding setup of system is idle state when the display closed; and proceeding to step (f) if it is determined to be negative; otherwise proceeding to step (h);
(f) inquiring in voice message for whether to setup of the system is in idle state in order to continue operation as the software will be disabled after closing the panel; and proceeding to step (g) if it is positive; otherwise proceeding to step (h);
(g) changing setting of the system as idle state while the display is closed;
(h) continuing to operate on the notebook computer, and continuing to detect whether the display closed;
(i) detecting whether signal for display closed is detected, and proceeding to step (j) if it is positive; otherwise proceeding to step (h);
(j) detecting whether proceeding setup of the system indicates idle state when display closed, and proceeding to step (q) if it is positive; otherwise proceeding to step (k);
(k) storing original proceeding setup of the system, and changing the proceeding setup into idle state;
(l) inquiring whether to change the proceeding setup and sending out a voice message as the software will be disabled after the panel closed, inquiring whether to setup the system as idling in order to continue the operation, and proceeding to step (m) if it is negative, otherwise proceeding to step (p);
(m) restoring previously stored original proceeding setup;
(n) executing the original proceeding setup of the notebook computer;
(o) ending operation method;
(p) changing the setting as idle state when the display closed; and
(q) shutting down power of display and activating voice identifier to continue the operation on the notebook computer.

2. A power control and operation method for notebook computer according to claim 1, wherein before shutting down the power of said display and activating the voice identifier, whether to send out an inquiry and then decide shutting down the power when the battery low is confirmed, and if it is confirmed to be positive, activating the function of inquiring whether to shut down the power when the battery low then activating said voice identifier; and if it is to be negative, activating the function of shutting down the power directly when the battery low and then activate said voice identifier.

3. A power control and operation method for notebook computer, wherein when a display of said notebook computer is closed, a power control enables a user to operate the notebook computer when connected to said audio receiver/player, said notebook computer comprises a CPU, an information receiver/saver connected to said CPU, a display and a switch being activated while said display is closed, and said information receiver/saver comprises a program stored therein, the operation method comprising activating the program and detecting whether the audio receiver/player is connected to said notebook computer, and detecting an original proceeding setup of a system; wherein if it is determined that the proceeding setup is not in idle state when the display is closed, a voice inquiry is sent out to inquire when to setup the system as idle state in order to continue operation to change the proceeding setup into idle state while display is closed, and the notebook computer continues the operation and detects the signal for display is closed, and shut down power of said display and activate the voice identifier for continuing operation on said notebook computer.

4. A power control and operation method for notebook computer according to claim 3, wherein after activating said program, said program is shut down if said audio receiver/player is not connected to said notebook computer.

5. A power control and operation method for notebook computer according to claim 3, wherein said program detects an original proceeding setup of said system is in idle state when said display is closed, said operation of notebook computer continues.

6. A power control and operation method for notebook computer according to claim 3, wherein said program detects an original proceeding setup of said system is not in idle state when said display is closed, a voice inquiry of whether setting up system as idle state in order to continue operation will sent out, and if the setting remains unchanged, said operation of notebook computer continues.

7. A power control and operation method for notebook computer according to claim 3, wherein said notebook computer detects a signal of display closed, said program will further detect whether said system is in idle state when said display is closed; if it is not, said original proceeding setup of said system is restored and change into idle state, and then whether to change a proceeding setup by a voice message as software disable when the display closed is inquired, and whether to setup system as idle state in order to continue the operation inquired, and change setting as idle state when the display is closed, and the display power is shut down and the voice identifier is activated in order to continue operation on the notebook computer; if the results to yes, the display power is shut down and the voice identifier is activated for continuing the operation of the notebook computer.

8. A power control and operation method for notebook computer according to claim 7, wherein said notebook computer detects a signal of display closed, said program detects the proceeding setup of the system is not idle state when the display is closed, and send out an inquiry whether to change the proceeding setup by voice message as software disables when the display is closed, whether to setup system as idle state is judged in order to continue the operation, if the proceeding setup remain unchanged, the stored proceeding setup will restored to enable the notebook computer to execute the original proceeding setup.
